(19) United States
(12) Patent Application Publication
(10) Pub. No.: US 2026/0125544 A1
(43) Pub. Date: May 7, 2026

(54) SINGLE-CHAIN NANOPARTICLE REINFORCED RUBBER MATERIAL AND PREPARATION METHOD THEREOF

(71) Applicant: Jilin University, Changchun (CN)

(72) Inventors: Hujun Qian, Changchun (CN); Yu Zhang, Changchun (CN)

(21) Appl. No.: 19/439,276

(22) Filed: Jan. 2, 2026

(30) Foreign Application Priority Data
Aug. 29, 2025 (CN) 2025112202106

(51) Int. Cl. C08L 9/00; B82Y 30/00; B82Y 40/00; C08J 3/24; C08K 3/06

(52) U.S. Cl. CPC C08L 9/00; C08J 3/247; C08K 3/06; B82Y 30/00; B82Y 40/00; C08J 2309/00; C08J 2333/14; C08L 2312/00

(57) ABSTRACT

A single-chain nanoparticle reinforced rubber material and a preparation method thereof are provided. The material includes 100 parts of a rubber base, 1-4 parts of sulfur, 1-3 parts of an accelerator, and 1-3 parts of acrylate single-chain nanoparticles, where the rubber base is isoprene rubber or natural rubber. The preparation method includes: blending and mixing the rubber base with the acrylate single-chain nanoparticles in an internal mixer, then adding sulfur and the accelerator for mixing, and finally compression molding and vulcanizing for shaping.

### CROSS REFERENCE TO RELATED APPLICATIONS

The present disclosure claims the priority to the Chinese patent application with the filing No. 202511220210.6, entitled “SINGLE-CHAIN NANOPARTICLE REINFORCED RUBBER MATERIAL AND PREPARATION METHOD THEREOF” and filed on Aug. 29, 2025 with the Chinese Patent Office, the contents of which are incorporated herein by reference in their entirety.

### TECHNICAL FIELD

The present disclosure relates to the technical field of reinforcement and modification of polymer elastomer materials, and more particularly to a single-chain nanoparticle reinforced rubber material and a preparation method thereof.

### BACKGROUND ART

In the field of rubber materials, it has always been a core research direction to improve mechanical strength and fracture toughness, and reduce dynamic energy consumption. Existing reinforcement methods, such as rigid fillers like carbon black and silicon dioxide, may improve material strength, but often lead to a decline in dynamic performance, making it difficult to meet the requirements of high-frequency applications. Strategies for enhancing toughness via sacrificial bond structures also have drawbacks such as high energy consumption and complex processing, making them difficult to balance performance and efficiency.

Natural rubber (NR) possesses an excellent elasticity but has a protein-induced allergenicity; and synthetic rubbers such as isoprene rubber (IR) have biosafety, but the mechanical performance requires further optimization. Therefore, it is of great significance to develop a novel rubber material that balances strength, toughness, processability, and low allergen risk.

In the prior art, the application of single-chain nanoparticles is mainly concentrated in thermoplastic polymer systems, but the application thereof in rubber systems is still relatively limited; and related research lacks systematic design methods and stable processing strategies, making it difficult to achieve synergistic optimization of performance and processability, which urgently needs to be further explored.

Therefore, it is a problem to be urgently solved by those skilled in the art to provide a single-chain nanoparticle reinforced rubber material and a preparation method thereof, thereby improving the mechanical performance and dynamic performance of the material, and simultaneously enhancing the processability to meet the application requirements of high-performance elastic materials.

### SUMMARY

In view of this, the present disclosure provides a single-chain nanoparticle reinforced rubber material and a preparation method thereof to solve the problems of high energy consumption, poor resilience, and insufficient processability existing in the prior rubber reinforcement approaches. By introducing single-chain nanoparticles with variable conformation and flexible interfaces, the present disclosure can significantly improve the strength and toughness of rubber materials, improve their dynamic performance and resilience, and reduce the viscosity of the rubber base and shorten the vulcanization time during processing. The prepared rubber material has high mechanical performance, low hysteresis loss, and good biocompatibility, making it suitable for medical products, soft robots, and other application fields with high requirements for flexibility and energy efficiency.

To achieve the above purposes, the present disclosure provides a single-chain nanoparticle reinforced rubber material and a preparation method thereof, adopting the following technical solution.

A single-chain nanoparticle reinforced rubber material includes the following raw materials in parts by weight: 100 parts of a rubber base, 1-4 parts of sulfur, 1-3 parts of an accelerator, and 1-3 parts of acrylate single-chain nanoparticles.

Further, the rubber base is isoprene rubber or natural rubber.

More further, the sulfur is sulfur OT-20, and the accelerator is an accelerator NS.

Further, the acrylate single-chain nanoparticles have side chains containing an ester group structure —COOR, where the R group is a saturated or unsaturated alkyl, an aryl, or a derivative thereof, including but not limited to groups such as a pentyl, a benzyl, and a double bond-containing benzyl or pentyl, and may regulate the polarity, crosslinking activity, and dispersion performance in the rubber systems of the particles. Specifically, the structure is as follows:

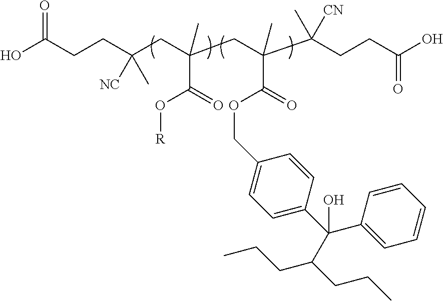

Structural formula of acrylate single-chain nanoparticles (SCNP).

In the solutions of the present disclosure, the single-chain nanoparticles, due to their flexibility, conformational adjustability, and excellent interfacial synergistic properties, become a novel approach of reinforcing elastomers. Compared with traditional inorganic fillers, single-chain nanoparticles exhibit better processing flowability, are less likely to cause wear on processing equipment, their incorporation into rubber may significantly reduce the viscosity of the rubber base, promote the vulcanization reaction rate, shorten the vulcanization time, and simultaneously improve mechanical performance and resilience. The acrylate single-chain nanoparticles used in the present disclosure are prepared according to the solution in CN116874650A. In the above, SCNP represents the acrylate single-chain nanoparticle, cSCNP is acrylate single-chain nanoparticle containing double bonds, and SCNPs generally refer to single-chain nanoparticles.

In the present disclosure, if the amount of acrylate single-chain nanoparticles added is too small, the strengthening and toughening effect cannot meet the requirements; and if the content of acrylate single-chain nanoparticles is too large, it may result in poor dispersibility of the product.

The present disclosure further provides a preparation method for the above-mentioned single-chain nanoparticle reinforced rubber material, including the following steps:
(1) weighing raw materials according to the above parts by weight;
(2) plasticating the weighed rubber base in an internal mixer for 2-3 min, and then adding the acrylate single-chain nanoparticles to the internal mixer for internal mixing to obtain a first rubber base;
(3) discharging the first rubber base, then milling into sheets on an open mill to obtain a second rubber base, and leaving the sheeted second rubber base to stand overnight;
(4) cutting into strips the second rubber base after standing, preheating in an oven, and then adding sulfur and the accelerator for internal mixing to obtain a rubber compound;
(5) the obtained rubber compound standing for 8-10 h, then testing the vulcanization curve of the rubber compound by using a rotor-less vulcanizer, where the actual vulcanization time is set by adding 5 min based on the positive vulcanization time TC90 measured from the vulcanization curve; and
(6) adding the rubber compound into a mold and vulcanizing in a plate vulcanizer to obtain the composite rubber.

Further, in step (2), the internal mixing is performed at a temperature of 60-70° C. and an internal mixer speed of 70 r/min for an internal mixing time of 10 min.

Further, in step (3), the open mill has a roller gap of 2.0-2.5 mm, a rotation speed of 15-20 r/min, a front roller temperature of 40-45° C., and a rear roller temperature of 45-50° C.; and the standing time is 18-24 h.

Further, in step (4), the second rubber base which is strip-shaped has a specification of 20*180 mm to 25*200 mm;

further, in step (4), in the oven, a preheating temperature of 70° C., and a preheating time of 10 min; and

more further, in step (4), the internal mixing is performed at a temperature of 60-70° C., and an internal mixer speed of 40 r/min for an internal mixing time of 2 min.

Further, in step (5), the rotor-less vulcanizer tests the rubber compound at a vulcanization temperature of 145° C. and a vulcanization pressure of 50 ton, and the actual vulcanization time is set by adding 5 min based on the positive vulcanization time TC90 obtained from the vulcanization curve.

Further, in step (6), the vulcanization temperature is 145° C., the vulcanization pressure is 50 ton, and the vulcanization time is 15-55 min.

The beneficial effects of the present disclosure are as follows.

The present disclosure provides a nano-reinforcement method suitable for isoprene rubber or natural rubber systems, which, on the premise of not relying on traditional rigid fillers, can significantly improve the overall performance of rubber materials and solve the problem that existing reinforcement approaches are difficult to balance strength, toughness, energy consumption, and processing adaptability. Its specific beneficial effects include the followings.

1. Improved overall mechanical performance: the material of the present disclosure has significantly improved key indicators such as tensile strength, elongation at break and fatigue life, and is suitable for dynamic working conditions with high requirements for durability and elasticity.

2. Low dynamic loss and excellent energy efficiency: the prepared material has low energy dissipation under dynamic loading conditions, relatively low hysteresis loss and excellent resilience, which helps to reduce an operating energy consumption and extend service life.

3. Processing friendliness and efficiency improvement: the nanoparticle-enhanced system introduced in the present disclosure is compatible with conventional internal mixing and vulcanization processes, and can shorten vulcanization time, reduce a processing temperature and an energy consumption, and improve an overall production efficiency on the basis of not changing the production process.

4. Strong process versatility and high I promotion potential: the reinforcement methods used may be completed through conventional internal mixing and molding processes, not only is applicable to physical blending but also may participate in chemical cross-linking, and thus has good processing adaptability and industrial promotion potential.

5. Excellent skin-friendliness and high biosafety: the material of the present disclosure does not contain natural rubber protein, has a low allergen risk, and is suitable for the application fields with high requirements for skin contact safety, such as medical gloves, condoms, medical balloons, and baby pacifiers.

### BRIEF DESCRIPTION OF DRAWINGS

FIG. 1 shows the synthesis schematic view of the acrylate single-chain nanoparticles containing double bonds in Example 1 of the present disclosure; and

FIG. 2 shows the nuclear magnetic resonance (1H NMR) spectrum of the acrylate single-chain nanoparticles containing double bonds in Example 1 of the present disclosure.

### DETAILED DESCRIPTION OF EMBODIMENTS

The technical solutions in the embodiments of the present disclosure will be clearly and completely described below in conjunction with the drawings in the embodiments of the present disclosure. Obviously, the described examples are only some of the embodiments of the present disclosure, not all of the embodiments. Based on the embodiments of the present disclosure, all other embodiments obtained by a person ordinarily skilled in the art without creative work fall within the scope of protection of the present disclosure.

### Example 1: Preparation Method of Single-Chain Nanoparticle Reinforced Rubber Material

(1) weighing out 100 parts per hundred (phr) of isoprene rubber, 3 phr of sulfur OT-20, 2 phr of an accelerator NS, and 2 phr of acrylate single-chain nanoparticles,
where the structure of the acrylate single-chain nanoparticles was as follows:

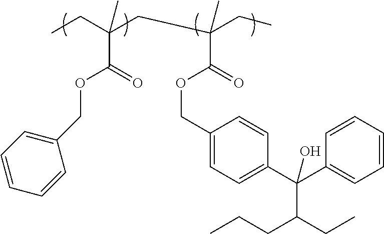

(2) plasticating the weighed rubber base in an internal mixer for 3 min, then adding the acrylate single-chain nanoparticles to the internal mixer for internal mixing at 65° C. and 70 r/min for 10 min to obtain the first rubber base;
(3) discharging the first rubber base and then milling into sheets on an open mill to obtain the second rubber base, where the open mill had a roller gap of 2.5 mm, a rotation speed of 20 r/min, a front roller temperature of 45° C., and a rear roller temperature of 50° C., and leaving the sheeted second rubber base to stand overnight;
(4) cutting into strips the second rubber base after standing, preheating in an oven at 70° C. for 10 min, then adding sulfur and the accelerator for internal mixing at 65° C. and 40 r/min for 2 min to obtain a rubber compound;
(5) the obtained rubber compound standing for 8 h, testing the vulcanization curve of the rubber compound by using a rotor-less vulcanizer, where the vulcanization temperature was 145° C. and the vulcanization pressure was 50 ton; and
(6) adding the rubber compound into a mold and vulcanizing in a plate vulcanizer at a vulcanization temperature of 145° C. and a vulcanization pressure of 50 ton for a vulcanization time of 30 min to obtain the composite rubber.

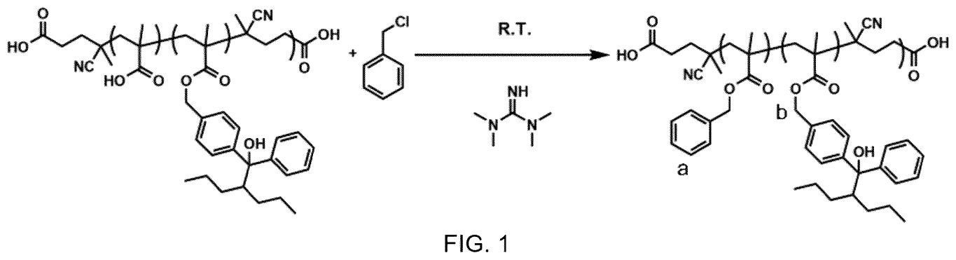

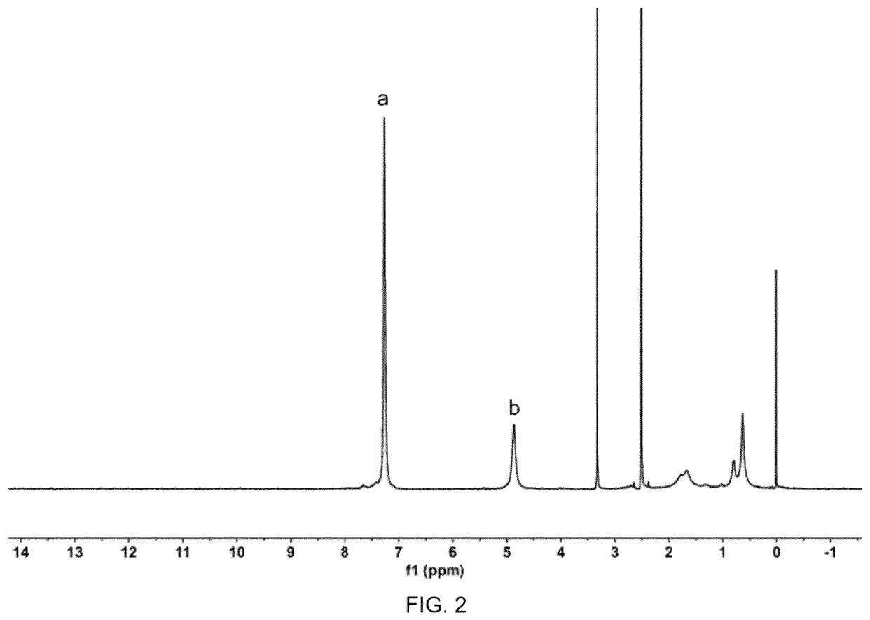

It can be seen from FIGS. 1-2 that the obtained acrylate single-chain nanoparticles exhibit characteristic peak positions in the nuclear magnetic spectrum, which are significantly different from those of the polymer precursor. The (aromatic hydrogen “a”) and (benzyl hydrogen “b”) on the polymer side chains show distinct peak signals within the range. This result verifies the successful synthesis of functionalized groups in the single-chain nanoparticles and provides a structural basis for subsequent compounding with a rubber matrix.

### Example 2

The solution was basically the same as that of Example 1, with the difference thereof being that the isoprene rubber was replaced by natural rubber.

### Example 3

The solution was basically the same as that of Example 1, with the difference thereof being that the acrylate single-chain nanoparticles were further replaced by acrylate single-chain nanoparticles containing double bonds.

In the above, the structure of acrylate single-chain nanoparticles containing double bonds was as follows:

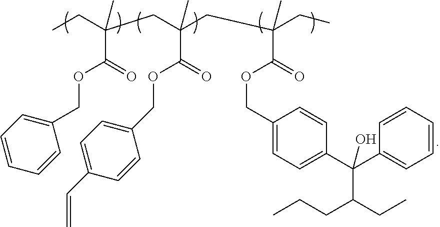

### Comparative Example 1

The solution was basically the same as that of Example 2, with the difference thereof being that the acrylate single-chain nanoparticles were replaced with carbon black (added in the same parts).

### Comparative Example 2

The solution was basically the same as that of Example 1, with the difference thereof being that no acrylate single-chain nanoparticles were added.

### Comparative Example 3

The solution was basically the same as that of Example 2, with the difference thereof being that no acrylate single-chain nanoparticles were added.

### Comparative Example 4

100 phr of isoprene rubber and 2 phr of acrylate single-chain nanoparticles were weighed, and directly mixed evenly to obtain the isoprene rubber-acrylate single-chain nanoparticle system.

### Test Example

The products of Examples 1-3 and Comparative Examples 1˜4 were subjected to performance characterization, and the results were as shown in Tables 1-3.

TABLE 1
Statistic Table of Complex Viscosity-Frequency Relationship
and Viscosity Reduction Amplitude of the Pure Isoprene
Rubber and Product of Comparative Example 4.

| | Isoprene | Viscosity of | |
|---|---|---|---|
| Angular | Rubber | Product in | Reduction |
| Frequency | Viscosity | Example 1 | Amplitude |
| ω (rad/s) | (Pa · S) | (Pa · S) | (%) |
| 100.00 | 2.64 × 10³ | 2.29 × 10³ | 13.4% |
| 39.81 | 6.02 × 10³ | 5.15 × 10³ | 14.5% |
| 15.85 | 1.35 × 10⁴ | 1.14 × 10⁴ | 15.8% |
| 10.00 | 2.00 × 10⁴ | 1.67 × 10⁴ | 16.6% |
| 6.31 | 2.95 × 10⁴ | 2.44 × 10⁴ | 17.4% |
| 3.98 | 4.32 × 10⁴ | 3.54 × 10⁴ | 18.1% |
| 1.58 | 9.03 × 10⁴ | 7.22 × 10⁴ | 20.0% |
| 0.63 | 1.82 × 10⁵ | 1.42 × 10⁵ | 22.1% |
| 0.16 | 4.77 × 10⁵ | 3.57 × 10⁵ | 25.2% |
| 0.01 | 2.21 × 10⁶ | 1.57 × 10⁶ | 29.3% |

As shown in Table 1, with the increase in angular frequency, the complex viscosities of the two samples, namely pure isoprene rubber (without vulcanization treatment) and the product of Comparative Example 4, both exhibit a typical decreasing trend, showing the characteristic of shear thinning. Compared with pure isoprene rubber, the product of Comparative Example 4 has a lower complex viscosity across the entire frequency range, especially in the low-frequency region, where the maximum reduction amplitude can reach approximately 29.3%. This result indicates that the introduction of acrylate single-chain nanoparticles significantly improves the flowability of the rubber, which helps reduce the shear resistance during the processing thereof, indicating that it has better processability and broader molding adaptability.

Note: the angular frequency in Table 1 indicates the speed of oscillatory loading, which is equivalent to scanning the viscoelasticity and flow resistance of the material at different time scales. The engineering interpretation thereof is as follows: the angular frequency may be considered as a quantitative indicator of “loading speed”. By scanning the angular frequency, the mechanical behavior of the material under different operating conditions may be simulated, for example, a long-term service or slow deformation are simulated in the low-frequency region; and rapid loading such as vibration and impact is simulated in the high-frequency region. Therefore, in the complex viscosity-angular frequency curve, the significance of angular frequency is to detect the evolution of the material's flow resistance and viscoelastic structure at different time scales.

TABLE 2
Comparison of Vulcanization Characteristics and
Mechanical Performances of Different Solutions

| | Vulcanization | 300% Constant | |
|---|---|---|---|
| | time | Tensile Stress | Toughness |
| Item | (min) | (MPa) | (MJ/m³) |
| Comparative | 54 | 0.65 | 16.00 |
| Example 2 | | | |
| Comparative | 15 | 0.80 | 16.72 |
| Example 3 | | | |
| Example 1 | 40 | 1.01 | 25.49 |
| Example 3 | 33 | 1.09 | 27.73 |

As shown in Table 2, the four rubber systems exhibit significant differences in vulcanization time and mechanical performance. The natural rubber system (Comparative Example 3) has shorter vulcanization time and higher constant tensile stress and toughness, showing better intrinsic performance. The isoprene rubber system (Comparative Example 2) has the longest vulcanization time and relatively weaker mechanical performance. After introducing acrylate single-chain nanoparticles, the constant tensile stress and toughness of the product system in Example 1 are significantly improved, and the vulcanization time is significantly shortened. After further introducing acrylate single-chain nanoparticles containing double bond structures, the strength, toughness, and vulcanization efficiency of the system in Example 3 are further improved, exhibiting the best overall performance, and indicating that this type of nanoparticles has significant advantages in the application in rubber reinforcement.

TABLE 3
Comparison of Fatigue Life of Different Solutions

| Item | Tensile Fatigue Life (times) |
|---|---|
| Example 1 | (2.88 ± 0.47) × 10⁵ |
| Example 2 | (1.15 ± 0.29) × 10⁶ |
| Example 3 | (2.65 ± 0.30) × 10⁵ |
| Comparative Example 1 | (6.60 ± 3.19) × 10⁵ |
| Comparative Example 2 | (1.95 ± 0.68) × 10⁵ |
| Comparative Example 3 | (5.62 ± 2.33) × 10⁵ |

It can be seen form the fatigue life test results as shown in Table 3 that the isoprene rubber material (Comparative Example 2) has the shortest fatigue life and is prone to crack propagation and structural failure under the action of cyclic loading. After the addition of acrylate single-chain nanoparticles, the fatigue life of the product material prepared in Example 1 is significantly improved, and after the further introduction of the double bond-containing acrylate single-chain nanoparticles with reactive side groups, the fatigue life in Example 3 is slightly lower than that of the physical blend system of Example 1, but still significantly better than that of the isoprene rubber in Comparative Example 2, demonstrating that acrylate single-chain nanoparticles play a positive role in enhancing the durability of isoprene rubber.

For the natural rubber system, the fatigue life of the natural rubber (Comparative Example 3) itself is relatively short, and Comparative Example 1 shows that the performance is improved after reinforcement with carbon black, but the improvement extent is limited. However, the material in Example 2 achieves an order-of-magnitude improvement in fatigue life, indicating that acrylate single-chain nanoparticles are also suitable for natural rubber systems, possess excellent potential for improving dynamic durability and are suitable for use in elastomer products with high-frequency cycling or high-load requirements.

Although embodiments of the present disclosure have been shown and described above, it can be understood that the above embodiments are exemplary and should not be construed as limiting the present disclosure. Those ordinarily skilled in the art may make changes, modifications, substitutions and variations to the above embodiments within the scope of the present disclosure.

1. A single-chain nanoparticle reinforced rubber material, comprising following raw materials in parts by weight: 100 parts of a rubber base, 1-4 parts of sulfur, 1-3 parts of an accelerator, and 1-3 parts of acrylate single-chain nanoparticles, wherein the rubber base is natural rubber, the sulfur is sulfur OT-20, and the accelerator is an accelerator NS;
the single-chain nanoparticles have an ester group structure-COOR, wherein the R group is a saturated or unsaturated alkyl, an aryl, or a derivative thereof, and a specific structure is as follows: 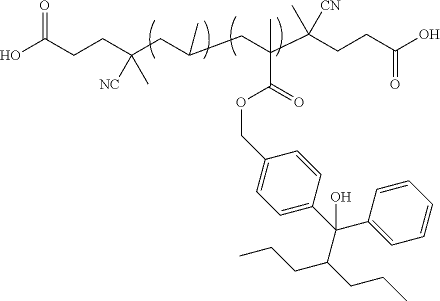
structural formula of the acrylate single-chain nanoparticles (SCNP).

2. A preparation method for the single-chain nanoparticle reinforced rubber material according to claim 1, comprising the following steps:
(1) weighing raw materials in parts by weight;
(2) plasticating the weighed rubber base in an internal mixer, and then adding the acrylate single-chain nanoparticles to the internal mixer for internal mixing to obtain a first rubber base;
(3) discharging the first rubber base, then milling into sheets on an open mill to obtain a second rubber base, and leaving the sheeted second rubber base to stand, wherein the open mill has a roller gap of 2.0-2.5 mm, a rotation speed of 15-20 r/min, a front roller temperature of 40-45° C., and a rear roller temperature of 45-50° C.; and a standing time is 18-24 h;
(4) cutting into strips the second rubber base after standing, preheating in an oven, and then adding sulfur and the accelerator for internal mixing to obtain a rubber compound;
(5) the obtained rubber compound standing for 8-10 h, testing a vulcanization curve of the rubber compound by using a rotor-less vulcanizer, wherein an actual vulcanization time is set by adding 5 min based on a positive vulcanization time TC90 measured from the vulcanization curve; and
(6) adding the rubber compound into a mold and vulcanizing in a plate vulcanizer to obtain a composite rubber, wherein a vulcanization temperature is 140-150° C., a vulcanization pressure is 50-52 tons, and a vulcanization time is 15-55 min.

3. The preparation method for the single-chain nanoparticle reinforced rubber material according to claim 2, wherein in step (2), the internal mixing is performed at a temperature of 60-70° C. and an internal mixer speed of 60-70 r/min for an internal mixing time of 5-10 min.

4. The preparation method for the single-chain nanoparticle reinforced rubber material according to claim 2, wherein in step (4), the second rubber base which is strip-shaped has a specification of 20*180 mm to 25*200 mm;
in the oven, a preheating temperature is 65-70° C., and a preheating time is 8-10 min; and
the internal mixing is performed at a temperature of 60-70° C. and an internal mixer speed of 30-40 r/min for an internal mixing time of 2-4 min.

5. The preparation method for the single-chain nanoparticle reinforced rubber material according to claim 2, wherein in step (5), the rotor-less vulcanizer tests the rubber compound at a vulcanization temperature of 140-150° C. and a vulcanization pressure of 50-52 ton, and an actual vulcanization time is set by adding 5 min based on a positive vulcanization time TC90 obtained from the vulcanization curve.
